(19) United States
(12) Patent Application Publication
(10) Pub. No.: US 2024/0059077 A1
(43) Pub. Date: Feb. 22, 2024

(54) MODULAR STACKING THERMAL PRINTERS

(71) Applicant: KODAK ALARIS INC., Rochester, NY (US)

(72) Inventors: Trevor WHITE, Rochester, NY (US); Joseph REPASS, Rochester, NY (US)

(73) Assignee: KODAK ALARIS INC., Rochester, NY (US)

(21) Appl. No.: 18/235,728

(22) Filed: Aug. 18, 2023

Related U.S. Application Data
(60) Provisional application No. 63/399,050, filed on Aug. 18, 2022.

(51) Int. Cl. B41J 2/32; B41J 11/00; B41J 11/70

(52) U.S. Cl. CPC B41J 2/32; B41J 11/009; B41J 11/70; B41J 3/60

(57) ABSTRACT

A modular simplex thermal printer that produces full color dye sublimation prints. Two individual modular printer units are stackable so that when the two simplex modular units are combined the lower printer unit can be loaded with duplex thermal receiver media which is printed on one side by the lower unit and then transferred through a slot and print transport path to the upper printer unit where the upper printer unit prints on the other non-printed side of the duplex receiver media.

### CROSS-REFERENCE TO RELATED APPLICATIONS

This application is a non-provisional of and claims priority to U.S. provisional application No. 63/399,050, filed on Aug. 18, 2022. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### BACKGROUND OF THE INVENTION

The present disclosure relates to modular printers that are capable of simplex and duplex printing. Embodiments described herein relate to modular simplex printers with multiple print transport paths for transferring print media from one modular printer to a second modular printer to enable duplex printing.

Duplex printing is a method of printing on both sides of a print medium instead of a single side performed by simplex printer units. The nature of modern printers with dedicated duplex printing results in a number of disadvantages due to their design. These duplex printers can be large and complex resulting in being expensive to both purchase and maintain. The complexity of duplex printers also requires specialized training for operation and maintenance.

Further, duplex printers require a print media change to convert from duplex to simplex printing. Additionally, when duplex printing is used for photo albuming applications, seasonal demand can result in underutilization of a dedicated duplex printer. Simplex printing with a duplex printer also results in additional thermal print heads which are unused during simplex printing. Therefore, there is a need in the art for a modular printing system capable of alternating between simplex and duplex printing.

### SUMMARY OF THE INVENTION

Described herein are embodiments of modular stacking thermal printers for simplex and duplex printing. One embodiment of the present invention provides for a method of operating a modular dye-sublimation thermal printing system. In some embodiments, two or more printer units can be mechanically and electrically connected. In embodiments, each unit can be a simplex printer with a computer processor, communication means, print media diverter, alternative print media path, and lateral receiver media cutter.

In some embodiments, a duplex print mode can be selected with at least two vertically stacked and connected units. A first side of a duplex print can be printed on duplex receiver media in the lower modular printer in some embodiments. A diverter can then be positioned to convey the print media to the upper modular print unit by an alternative receiver transport path. The print media can be cut by the lower print unit at this time.

In other embodiments, the second side of the duplex print can be printed by the upper modular printing unit. The diverter can then be positioned such that the media is transferred through the exit slot of the upper unit.

In some embodiments, alphanumeric human readable code, machine readable code, or an RFID chip can be present in the receiver media to identify the type of media. In these embodiments, the media type can be identified by an RFID chip reader, media type sensor, or by user input. In some embodiments, the media sensor is an optoelectrical, electrical resistance, or acoustic sensor.

In certain embodiments, the system can be automatically configured for duplex and simplex printing when duplex print media is identified in the lower printer and simplex print media is identified in the upper printer. In other embodiments, the system can be automatically configured for parallel simplex printing when simplex print media is identified in both the lower and upper printers. Alternatively, an error can be presented when duplex print media is identified in the upper printer.

In some embodiments, the printers can be connected through projections and cavities on the surfaces of the individual units. These projections and cavities can be accessed through covers or doors. In other embodiments, the internals of the printers can be access through sliding doors or removable panels. These can be used for maintenance, repair, jam clearing, and loading dye donors and receiver medias.

In some embodiments, the diverter and alternative media path can be low friction surfaces. In other embodiments, these can also include optoelectrical, electrical resistance, or acoustic receiver media position sensors. The diverter can selectively redirect the print media to a media supply path, alternative print media path, or print media exit slot. In some embodiments, the print output options, workflows, and user interface can be modified based on the dye donors and receiver print media types loaded into the modules.

A second embodiment of the present invention provides for a method of operating a dye-sublimation thermal printer system. The system can include three or more vertically stacked printer units that are mechanically and electrically connected. Each unit can include a computer processor, communication means, print media diverter, alternative print media path, lateral receiver media cutter, and processing logic. The system can automatically configure the system and output options based on the number of stacked units and types of donor and receiver medias installed in each unit.

In some embodiments, the print receiver media can be simplex, duplex, adhesive backed, magnetic backed, in-line pre-scored, in-line pre-perforated, foil-backed, or pre-printed. In other embodiments, the donor types can be different patch size formats and configurations, four color patch (cyan, magenta, yellow, and clear overcoat), two patch (monochrome dye and clear overcoat), and metal foil.

### BRIEF DESCRIPTION OF THE DRAWINGS

The present technology will be better understood upon reading the following detailed description of non-limiting embodiments and examining the accompanying drawings, which are summarized as follows.

FIG. 1 depicts a single printing module according to an embodiment of the technology.

FIG. 2 depicts a single printing module performing simplex printing functions according to an embodiment of the technology.

FIG. 3 depicts two stacked printing modules according to an embodiment of the technology.

FIG. 4 depicts two stacked printing modules performing duplex printing functions according to an embodiment of the technology.

FIG. 5 depicts two stacked printing modules performing parallel simplex printing functions according to an embodiment of the technology.

FIG. 6 depicts three stacked printing modules for performing simplex and duplex printing functions.

### DETAILED DESCRIPTION

Aspects, features, and advantages of the present technology will be further appreciated when considered with reference to the following description of embodiments and accompanying drawings. In describing embodiments of the technology, including particular embodiments illustrated in the drawings, specific terminology will be used for the sake of clarity. The embodiments of the present technology, however, are not intended to be limited to the specific terms used, and it is to be understood that each specific term can include equivalents that operate in a similar manner to accomplish a similar purpose. To the extent features of the present technology are depicted in the drawings in different embodiments, it should be understood that features from different embodiments can be combined to achieve the full functionality described herein unless expressly disclaimed otherwise.

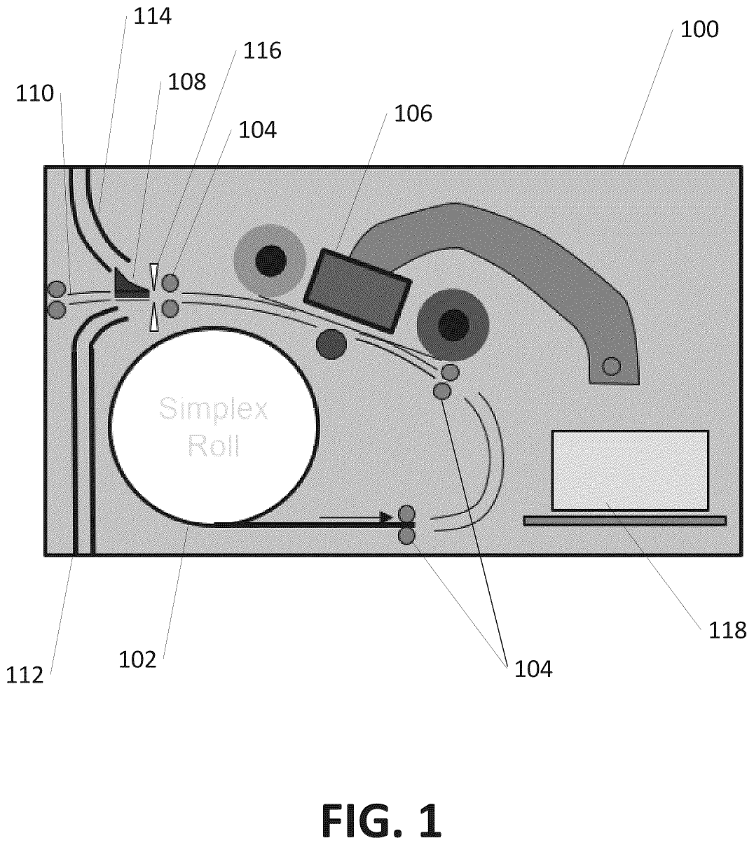

FIG. 1 depicts a single dye sublimation printing module 100 according to an embodiment of the technology. The module can include a print media roll 102. The print media roll 102 can be simplex print media, duplex print media, or print media designed for either simplex or duplex printing. In the current embodiment, a simplex roll of print media is shown. Rollers 104 can be used to transport the print media past the print head 106.

The print media 102 can include a means of identifying the type of media in the roll. This can be through the inclusion of alphanumeric human or machine-readable code within the print media 102. An RFID chip may also be associated with the print media 102 for identifying the type of media. The printing module 100 can have an associated means to receive the media type information. This can include through manual entry, a sensor or scanner, or an RFID chip reader. The sensors can be an optoelectrical sensor, electrical resistance sensor, or acoustic detection sensor.

The module can further include a print media diverter 108 and multiple media paths. This can include an exit slot 110, a media supply path 112, and an alternative print media path 114. The print media diverter 108 can move the print media between the paths based on the desired simplex or duplex printing. Lateral receiver media cutter 116 can also be provided for dividing finished products. The print media diverter 108, media supply path 112, and alternative print media path 114 can be made of low friction materials. This can prevent scratches on the print media when it is being transported through the module. The print media diverter 108, media supply path 112, and alternative print media path 114 can also include sensors for monitoring media position. These sensors can include optoelectrical sensors, electrical resistance sensors, or acoustic sensors.

The printer module 100 can further include a computer processor 118. The computer processor 118 can include any appropriate means of communication for receiving print instructions. The processor 118 can be connected to a user interface for receiving printing instructions and providing printing configurations.

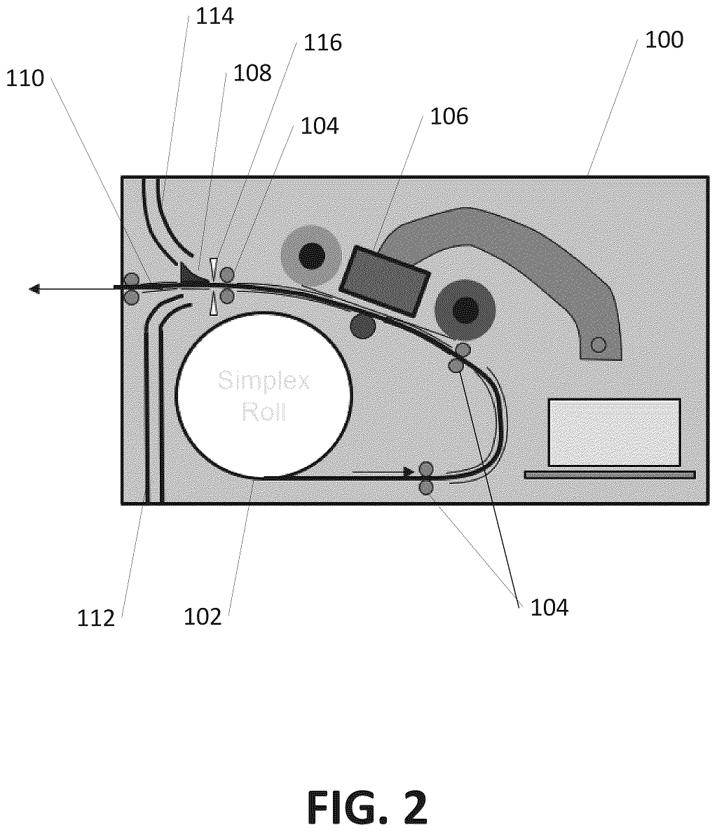

FIG. 2 depicts a single dye sublimation thermal printing module performing simplex printing according to an embodiment of the present invention. Here, the print media in the print media roll 102 can be transported by the rollers 104 past the print head 106. The print head 106 prints the desired donor onto a single side of the print media. The print media diverter 108 can be in a first position which directs the printed material towards the exit slot 110.

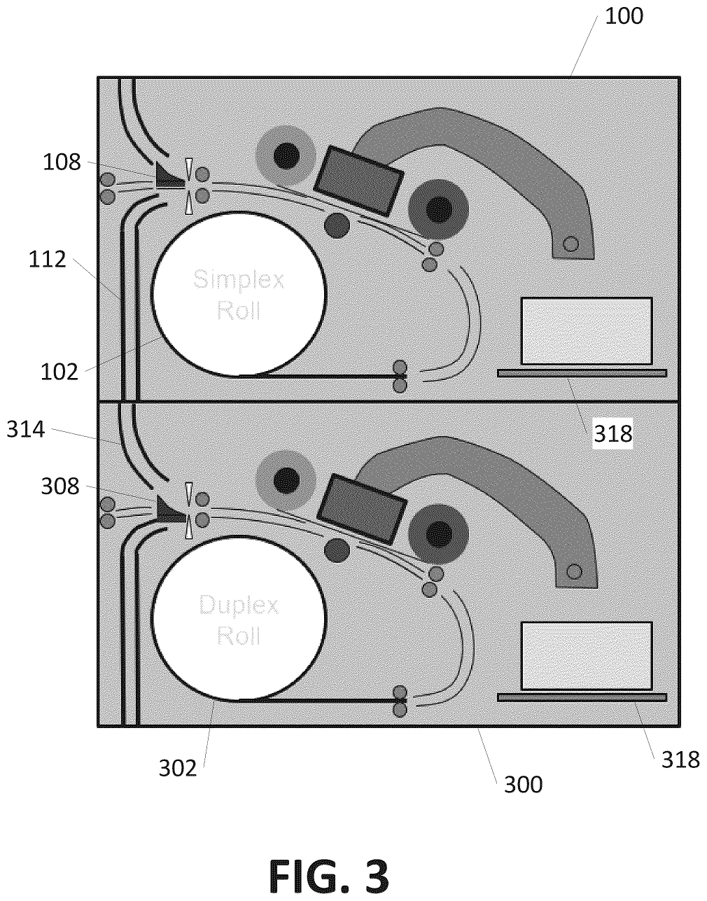

FIG. 3 depicts two stacked dye sublimation thermal printing modules 100 and 300 according to an embodiment of the present invention. The printing modules 100 and 300 can be identical such that the printing modules have similar components. While in the present embodiment, printing module 100 is positioned on top of printing module 300, the reverse can also occur with printing module 300 located on top of printing module 100. The print media roll 102 of the first module can include print material for simplex printing while the print media roll 302 of the second printing module can be print material for duplex printing.

In the embodiment, the media supply path 112 of the first module can align with the alternative print media path 314 of the second module. This can allow print media from the second module 300 to be passed to the first module 100 by the print media diverter 308 of the second module.

The first and second printing modules can further be electronically connected such that the computer processor 118 of the first printing module 100 can communicate with the computer processor 318 of the second printing module 300. When connected, the modules can be configured to automatically allow both duplex and simplex printing. When disconnected, the modules can be configured to produce only simplex prints. The modules can be connected by the presence of projections and cavities on the top and bottom surfaces of the modules where the top surface can complement the shape of the bottom surface. The projections and cavities can further be accessed by removing covers or moving hinged or sliding doors such that the projections and cavities may not be accessible when the modules are not connected.

The module can have access points on the vertical side of the module for accessing the internal printer components. These can allow for maintenance, repair, jam clearing, donor material replacement, and media replacement even in the shown stacked configuration. The access points can be sliding drawers, doors, or removable panels.

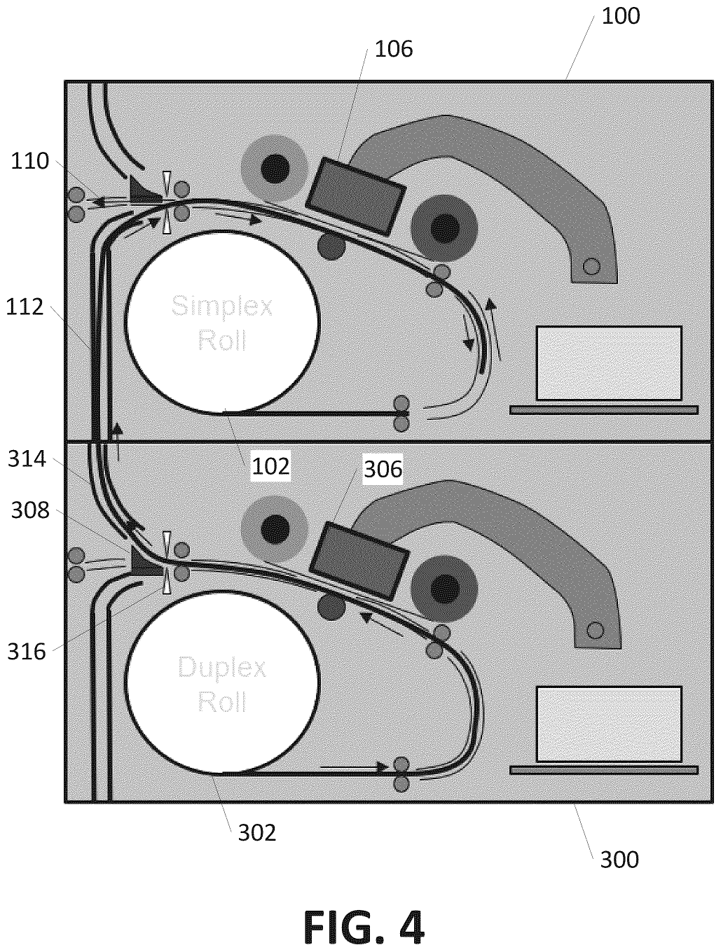

FIG. 4 depicts two stacked dye sublimation thermal printing modules performing duplex printing according to an embodiment of the invention. Duplex printing can be initially performed similarly to the simplex printing depicted in FIG. 2. In this embodiment, the second module 300 feeds duplex print material 302 through the print head 306 of the second module. After printing the first side on the print media, the print media diverter 308 can be in a second position configured to feed the print media through the alternative print media path 314 of the second module and into the media supply path 112 of the first module. The print media can then be directed past the print head 106 of the first module to print the second side on the print media. The stacked printing modules can be configured such that no further manipulation of the print media is required other than the transfer from the second module to the first module.

After the duplex printing is complete, the print media can be reversed out of the first print module and through the exit slot 110 due to the first print media diverter 108 being in the first position. The finished product can be cut by the lateral receiver media cutter 316 before this occurs. After the finished product is discharged from the first module 100, additional print media can be fed into the first module 100 by the second module 300.

In this configuration, duplex printing media can be placed in the second module 300 while simplex printing media can be placed in the first module 100. The system can further be configured to provide an error if duplex print media is placed in the upper module, which would be the first module 100 of the present embodiment.

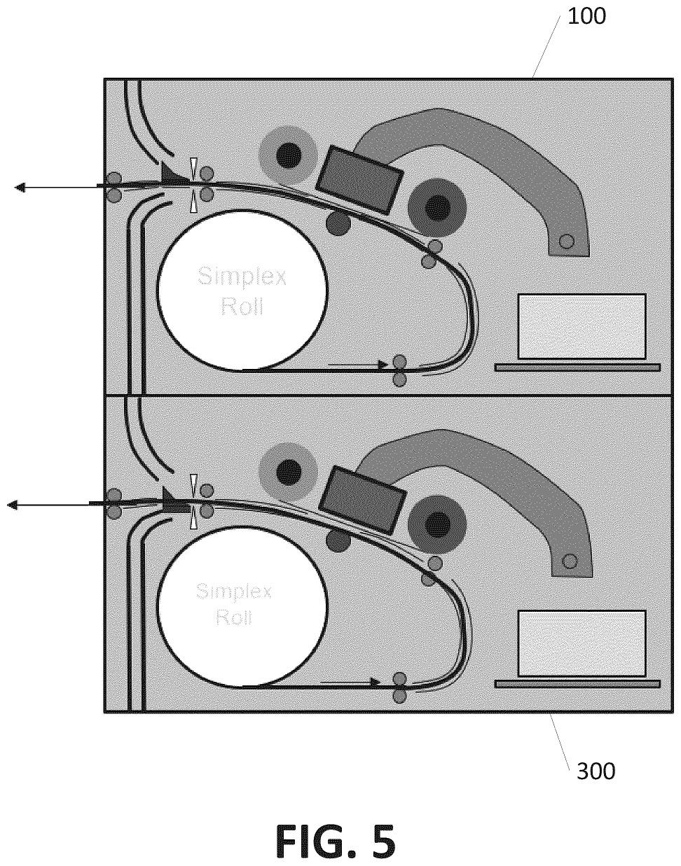

FIG. 5 depicts two stacked printing modules performing parallel simplex printing according to an embodiment of the invention. This embodiment is similar to FIG. 2 where simplex printing is shown being performed on a single module. In this embodiment, both the first and second modules 100 and 300 both perform the simplex printing of FIG. 2. This can keep all print heads in active use during simplex print jobs and double the throughput through both systems by using both modules simultaneously, increasing print efficiency. This configuration can be automatically identified when simplex print media is present in both the upper and lower printing modules as shown in FIG. 5.

The modules can be configured to modify a user interface based on the configuration of the system. This can include offering only certain print output options or workflows. This can be based on the type of print media and donor material loaded into each module and the configuration of the overall system.

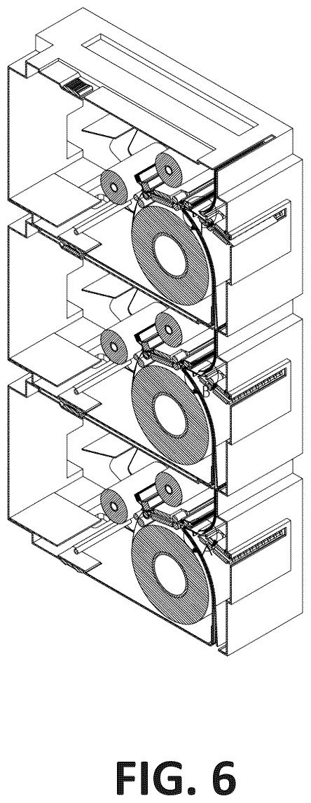

The system can further be configured to support additional modules as shown in FIG. 6. The system can further be configured for additional modules than the three shown in FIG. 6. The system can automatically configure for additional printing options based on the number of stacked modules and type of print media and donor material loaded into each module. The print media can include simplex, duplex, adhesive backed, magnetic backed, in-line pre-scored, in-line pre-perforated, foil-backed, and/or pre-printed media. The donor material can include different patch size formats and configurations, four color patch (cyan, magenta, yellow, and clear overcoat), two patch (monochrome dye and clear overcoat), and metal foil.

The invention claimed is:

1. A method of operating a modular dye-sublimation thermal printer system, comprising:
mechanically and electrically connecting two or more modular dye-sublimation thermal printer units in a vertically stacked arrangement wherein each unit is a simplex printer equipped with a computer processor, communication means, print media diverter, alternative print media path, and lateral receiver media cutter.

2. The method of claim 1 further comprising:
selecting a duplex print mode with two printer units vertically stacked and connected;
printing a first side of a duplex receiver media in a lower modular printer unit;
positioning a diverter in the lower modular printer unit in a second position;
conveying the print media to an upper modular printer unit via the alternative receiver transport path of the lower unit;
cutting the print media by the lower modular printer lateral print receiver media cutter;
printing a second side of the duplex print media by the upper modular printer unit;
positioning a diverter in the upper modular printer unit in a first position; and
transferring through the upper printer unit diverter to an exit slot of the upper modular printer unit.

3. The method of claim 1 further comprising:
identifying a receiver media type by a RFID chip reader, receiver media type sensor, or by user input; and
wherein a receiver media comprises an alphanumeric human readable code, machine-readable code, or RFID chip.

4. The method of claim 3 wherein the receiver media type sensor determines the receiver media type by analyzing the receiver media using optoelectrical, electrical resistance, or acoustic detection means.

5. The method of claim 1 further comprising:
automatically configuring the printer units to produce duplex and simplex prints when duplex print media is identified in the lower modular printer and simplex print media is identified in the upper modular unit.

6. The method of claim 1 further comprising:
automatically configuring the printer units to produce parallel simplex prints when simplex print media is identified in both the lower modular printer and the upper modular unit.

7. The method of claim 1 further comprising:
automatically providing an error message when duplex print media is identified in the upper modular unit.

8. The method of claim 1 wherein the mechanically and electrically connecting means comprises interface projections and cavities accessible by removing covers or moving hinged or sliding doors.

9. The method of claim 1 further comprising:
accessing the modular printing units by sliding drawers, one or more front access doors, or removable front panels for maintenance, repair, jam clearing, and loading dye donor and receiver medias.

10. The method of claim 1 wherein print the media diverter and/or alternative print media path comprise low friction surfaces to prevent scratches on printed and unprinted receiver media surfaces.

11. The method of claim 1 wherein print the media diverters and alternative print media paths comprise optoelectrical, electrical resistance, or acoustic receiver media position sensors.

12. The method of claim 1 wherein the print media diverter selectively redirects the print media to a media supply path, alternative print media path, or print media exit slot.

13. The method of claim 1 wherein print output options, operational workflows, and user interface is modified based on a dye donor and receiver print media types loaded into the printer modules.

14. A method of operating a modular dye-sublimation thermal printer system, comprising:
mechanically and electrically connecting three or more modular dye-sublimation thermal printer units in a vertically stacked arrangement wherein each unit is a simplex printer equipped with a computer processor, communication means, print media diverter, alternative print media path, lateral receiver media cutter, and processing logic; and
automatically configuring the operation of the printer system and print output options based on the number of units that are mechanically and electrically connected in a vertically stacked arrangement and types of donor and receiver medias installed in each unit.

15. The method of claim 14 wherein the print receiver media types comprise simplex, duplex, adhesive backed, magnetic backed, in-line pre-scored, in-line pre-perforated, foil-backed, or pre-printed.

16. The method of claim 14 wherein the donor types comprise different patch size formats and configurations, four color patch (cyan, magenta, yellow, and clear overcoat), two patch (monochrome dye and clear overcoat), and metal foil.
